(19) United States
(12) Patent Application Publication
(10) Pub. No.: US 2026/0170659 A1
(43) Pub. Date: Jun. 18, 2026

(54) THREE-DIMENSIONAL MACHINE VISION SYSTEM WITH SUBPIXEL PRECISION

(71) Applicant: Cognex Corporation, Natick, MA (US)

(72) Inventors: André Schweier, Freiburg (DE); Michael C. Moed, Hopkinton, MA (US); Nitin M. Vaidya, Shrewsbury, MA (US)

(73) Assignee: Cognex Corporation, Natick, MA (US)

(21) Appl. No.: 19/420,269

(22) Filed: Dec. 15, 2025

Related U.S. Application Data
(60) Provisional application No. 63/735,273, filed on Dec. 17, 2024.

(51) Int. Cl. G06T 7/13; G06T 7/00; G06T 7/246; G06T 7/521; G06T 7/60; G06T 7/73

(52) U.S. Cl. CPC G06T 7/13; G06T 7/0006; G06T 7/246; G06T 7/521; G06T 7/60; G06T 7/74; G06T 2207/30108

(57) ABSTRACT

Three-dimensional machine vision system with subpixel precision are provided herein. A system configured to generate a three-dimensional (3D) image of a physical environment. The system comprises a photonic module configured to project a laser line onto a surface in the physical environment, and an imaging device configured to capture a two-dimensional (2D) image of the projected laser line. The photonic module and the surface are in relative motion in a physical y-direction. The 2D image comprising pixel columns extending in an image Y direction, which corresponds to a physical z-direction, and aligned in an image X direction, which corresponds to a physical x-direction. The system comprises a processor configured to identify an edge of the captured laser line with a subpixel precision in the image X direction.

### RELATED APPLICATIONS

This Application claims priority under 35 U.S.C. § 119(e) to U.S. Provisional Application Ser. No. 63/735,273, titled “THREE-DIMENSIONAL MACHINE VISION SYSTEM WITH SUBPIXEL PRECISION,” filed on Dec. 17, 2024, which is herein incorporated by reference in its entirety.

### FIELD

The techniques described herein relate generally to imaging systems, including machine vision systems that are configured to acquire and analyze three-dimensional (3D) images of objects.

### BACKGROUND

Machine vision systems are generally configured to capture images and to analyze the images. For example, machine vision systems can be configured to capture images of objects and to analyze the images to identify the objects. As another example, machine vision systems can be configured to capture images of symbols and to analyze the images to decode the symbols. Accordingly, machine vision systems generally include one or more devices for image acquisition and image processing.

### SUMMARY

Aspects of the present disclosure relate to three-dimensional machine vision systems with subpixel precision.

Some embodiments relate to a system configured to generate a three-dimensional (3D) image of a physical environment. The system may comprise a photonic module configured to project a line onto a surface in the physical environment, wherein the photonic module and the surface are in relative motion in a first physical direction; an imaging device configured to capture a two-dimensional (2D) image of the projected line, the 2D image comprising a plurality of pixel columns extending in an image Y direction and aligned in an image X direction, the image X direction corresponding to a second physical direction perpendicular to the first physical direction, the image Y direction corresponding to a third physical direction perpendicular to both the first physical direction and the second physical direction; and at least one processor configured to identify an edge of the captured line with a subpixel precision in the image X direction.

Optionally, the at least one processor is configured to: preselect a plurality of subpixel candidates from the plurality of pixel columns; for the plurality of preselected subpixel candidates, determine respective subpixel positions; and determine the edge of the captured laser line by interpreting the determined subpixels positions.

Optionally, the plurality of subpixel candidates are preselected based on metric pixels of respective pixel columns.

Optionally, the processor is configured to, for each of the plurality of pixel columns: determine the metric pixel of the pixel column; determine whether the brightness of the metric pixel exceeds a predefined threshold; if the brightness of the metric pixel exceeds the predefined threshold, sum pixel values of a predetermined number of pixels on the left side as well as on the right side of the metric pixel; determine a ratio by dividing the pixel values of one of the sides having the lower sum by the pixel values of the other one of the sides having the higher sum; and if the ratio is below a predefine value, preselect the pixel column as a subpixel candidate.

Optionally, the processor is configured to, for each of the plurality of pixel columns: determine the metric pixel of the pixel column; determine whether the brightness of the metric pixel exceeds a predefined threshold; if the brightness of the metric pixel exceeds the predefined threshold, sum pixel values of a predetermined number of pixels on the left side as well as on the right side of the metric pixel; determine a ratio by dividing the pixel values of one of the sides having the higher sum by the pixel values of the other one of the sides having the lower sum; and if the ratio exceeds a predefine value, preselect the pixel column as a subpixel candidate.

Optionally, the metric pixel and the predetermined number of pixels on the left and right sides of the metric pixel together define a measurement window in the image X direction; and if the pixel column is preselected as a subpixel candidate, the subpixel position for the pixel column is determined by applying a moments-based method to the measurement window.

Optionally, the processor is configured to: determine a distance between the determined subpixel position and a center of the measurement window; and if the distance is less than a predetermined length, assign the determined subpixel position as the edge of the captured line. Optionally, the processor is configured to, if the distance is greater than the predetermined length: determine whether the determined subpixel position is on a brighter side of the center of the measurement window; if the determined subpixel position is on a brighter side of the center of the measurement window, discard the pixel column; and if the determined subpixel position is on a darker side of the center of the measurement window, assign the pixel column as part of the captured line.

Optionally, the determined length is a half of a pixel length in the image X direction.

Optionally, the processor is configured to: for each of the determined subpixel candidates, determine a distance between the determined subpixel position and a center of the respective measurement window; and assign the subpixel candidate that has a smallest distance as the edge of the captured line.

Optionally, for the preselected subpixel candidates, the subpixel positions are determined by a moments-based method.

Optionally, for the preselected subpixel candidates, the subpixel positions are determined by a curve-fitting method.

Optionally, the processor comprises a field-programmable gate array (FPGA).

Optionally, the photonic module is configured to project the line onto the surface in the physical environment with reduced speckle.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto. It is to be understood that the phraseology and terminology employed herein are for the purpose of description and should not be regarded as limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a schematic diagram illustrating an exemplary machine vision system configured to capture three-dimensional (3D) images of objects, according to some embodiments.

FIG. 2A is a schematic diagram illustrating an object scanned by a laser line, according to some embodiments.

FIG. 2B is a schematic diagram illustrating a two-dimensional (2D) image, with an image x-direction (XI) and an image y-direction (YI), of the captured laser line across the object in FIG. 2A, showing the 2D image having a plurality of pixel columns extending in the YI direction and aligned in the XI direction, according to some embodiments.

FIG. 3A is a schematic diagram illustrating an object scanned by a laser line, according to some embodiments.

FIG. 3B is a 2D image of the captured laser line across the object in FIG. 3A, according to some embodiments.

FIG. 3C is a graph of the pixel values for individual pixel columns of the 2D image of FIG. 3B.

FIG. 4 is a flow chart illustrating a method of providing subpixel precision for a captured laser line in the XI direction, according to some embodiments.

FIG. 5 is a flow chart illustrating a method of preselecting subpixel candidates, according to some embodiments.

FIG. 6 is a schematic diagram illustrating applying the method of preselecting subpixel candidates of FIG. 5 to the 2D image of FIG. 3B, showing a measurement window.

FIG. 7 is a schematic diagram illustrating results of applying the method of preselecting subpixel candidates of FIG. 5 to the 2D image of FIG. 3B.

FIG. 8 is a schematic diagram illustrating results of applying a method of interpreting estimated subpixel positions for preselected subpixel candidates of FIG. 7.

FIG. 9A is a schematic diagram illustrating a first potential result between the determined subpixel position in FIG. 8 and the center of a measurement window that may be used in preselecting the corresponding subpixel candidate, according to some embodiments.

FIG. 9B is a schematic diagram illustrating a second potential result of a distance between the determined subpixel position in FIG. 8 and the center of a measurement window that may be used in preselecting the corresponding subpixel candidate, according to some embodiments.

FIG. 9C is a schematic diagram illustrating a third potential result of a distance between the determined subpixel position in FIG. 8 and the center of a measurement window that may be used in preselecting the corresponding subpixel candidate, according to some embodiments.

FIG. 10A is an image of an electronic device.

FIG. 10B is a 3D image of the electronic device of FIG. 10A, without subpixel precision for captured laser lines in the XI direction.

FIG. 10C is a 3D image of the electronic device of FIG. 10A, with subpixel precision for captured laser lines in the XI direction.

FIG. 11A is an image of a surface with a hole and scratches.

FIG. 11B is a 3D image of the surface of FIG. 11A, without subpixel precision for captured laser lines in the XI direction.

FIG. 11C is a 3D image of the surface of FIG. 11A, with subpixel precision for captured laser lines in the XI direction.

### DETAILED DESCRIPTION

The techniques described herein provide three-dimensional (3D) machine vision systems that can provide subpixel precision. Such machine vision systems can provide higher resolution at lower costs than, for example, using a larger image sensor. Such machine vision systems can be used to perform various machine vision tasks. For example, such machine vision systems can be used to measure the dimensions of parcels in the logistics industry, to inspect manufactured goods in the automation of factories, and/or to perform other processes that leverage machine vision.

Conventional machine vision systems may have a gap in measurement precisions between the height direction and the surface direction. While conventional machine vision systems may be able to determine relatively accurate heights of target objects, they are limited to the pixel count in determining the edge positions of target objects. Machine vision systems with subpixel precision described herein can provide more accurate measurement than conventional machine vision systems, and identify features (e.g., defects) that may not be detected by conventional machine vision systems.

Such a machine vision system can include a photonic module configured to project laser lines onto surfaces in a physical environment, and an imaging device configured to capture two-dimensional (2D) images of the projected laser lines from an angle different from the photonic module. A 2D image can be captured for each laser line projected onto surfaces of target objects and surrounding surfaces. Each 2D image can have pixel columns extending in an image Y direction and aligned in an image X direction.

Target objects can have relative movements with respect to the photonic module and imaging device in a first physical direction (e.g., physical y-direction). The image X direction can correspond to a second physical direction (e.g., physical x-direction) and reflect edges of a target object. The image Y direction can correspond to a third physical direction (e.g., physical z-direction) and contain heights of the target object. 2D images of the laser lines captured at different times therefore can contain dimensional information of target objects in the second and third physical directions (e.g., physical x-direction and physical z-direction) at different locations in the first physical direction (e.g., physical y-direction). A three-dimensional (3D) image for a target object can be generated based on the 2D images of the laser lines captured at different times. It should be appreciated that the photonic module can be positioned colinearly and/or at offset angle(s) around physical x, y, and z-directions relative to the motion of the object it is observing. For example, when positioned over a conveyor belt which moves in a physical y direction, the photonic module can be mounted with an offset angle so that the image Y direction is not colinear with the physical z-direction and/or the image X direction is not colinear with the physical x-direction.

The machine vision system can include at least one processor configured to execute computer executable instructions comprising instructions for identifying, in a 2D image, an edge of the captured laser line with a subpixel precision in the image X direction. The subpixel positions of edges in image coordinates can be converted to physical positions, which can yield more precise measurements. Examples of the at least one processor include, but are not limited to, a programmable processor, a field-programmable gate array (FPGA), a digital signal processor (DSP), a central processing unit (CPU), a graphics processing unit (GPU), and/or an application-specific integrated circuit (ASIC).

Identifying an edge of the captured laser line with a subpixel precision in the image X direction of a 2D image can include preselecting subpixel candidates from the pixel columns of the 2D image. Such a configuration can avoid applying subpixel computation on all of the pixel columns in each 2D image and therefore alleviate computational burden. In some embodiments, in a first step, for a pixel column, a metric pixel may be determined based on, for example, the brightnesses of the pixels in the column and/or the locations of the pixels in the column. As an example, the brightest pixel in a pixel column may be determined and selected as the metric pixel.

As another example, multiple brightest pixels in a pixel column may be determined; and the metric pixel may be selected based on the location of these multiple brightest pixels. For instance, the multiple brightest pixels may correspond to stacked surfaces scanned by the laser line. When the top surface is of interest, the up-most brightest pixel may be selected as the metric pixel. When the bottom surface is of interest, the bottom-most brightest pixel may be selected as the metric pixel.

As a further example, for a pixel column, the brightnesses of a number (e.g., an odd number n) of adjacent pixels in a pixel column may be summed. If the sum exceeds a predetermined value, the metric pixel may be selected from the number of adjacent pixels (e.g., the center pixel). Alternatively, the metric pixel may be selected based on a curve (e.g., a Gaussian curve) fitted to the number of adjacent pixels.

In a second step, it may then be determined whether the brightness of the metric pixel exceeds a predefined threshold. If the brightness of the metric pixel exceeds the predefined threshold, pixel values of a predetermined number of pixels on the left side may be summed, as well as on the right side of the metric pixel. A ratio may then be determined by dividing the pixel values of one of the sides having the lower sum by the pixel values of the other one of the sides having the higher sum. If the ratio is below a predefined value, the pixel column is preselected as a subpixel candidate. Alternatively, a ratio can be determined by dividing the pixel values of one of the sides having the higher sum by the pixel values of the other one of the sides having the lower sum. If the ratio exceeds a predefined value, the pixel column is preselected as a subpixel candidate.

Identifying an edge of the captured laser line with a subpixel precision in the image X direction of a 2D image can include, for the preselected subpixel candidates, determining subpixel positions. Examples of methods to determine the subpixel positions include, but are not limited to, reconstructive methods, moments-based methods, and curve-fitting methods. In some embodiments, the brightest pixel and the predetermined number of pixels on the left and right sides of the metric pixel together define a measurement window in the image X direction. If the pixel column is preselected as a subpixel candidate, the subpixel position for the pixel column is determined by applying a moments-based method to the measurement window.

Identifying an edge of the captured laser line with a subpixel precision in the image X direction of a 2D image can include determining the edge of the captured laser line by interpreting the determined subpixel positions. In some embodiments, a distance between the determined subpixel position and a center of the measurement window may be determined. If the distance is less than a predetermined length, the determined subpixel position may be assigned as the edge of the captured laser line. If the distance is greater than the predetermined length, it may be determined whether the determined subpixel position is on a brighter side of the center of the measurement window. If the determined subpixel position is on a brighter side of the center of the measurement window, the pixel column may be discarded so as not to be used for generating the 3D image. If the determined subpixel position is on a darker side of the center of the measurement window, the pixel column can be assigned as part of the captured laser line so as to be used for generating the 3D image. It should be appreciated that although the above description assumes the pixel location is in the center of the pixel and the subpixel location extends to either the left or the right of the center, this need not be the case. For example, alternative embodiments can assume that the pixel position is at the left edge of the pixel and that the subpixel location extends to the right of the left edge. Another alternative embodiment can assume the pixel position is at the right edge of the pixel and the subpixel location extends to the left of the right edge.

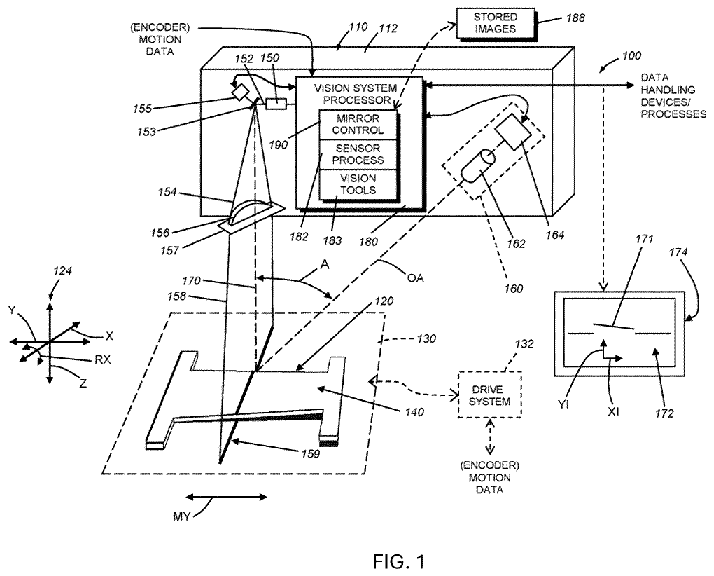

FIG. 1 shows a vision system arrangement 100 including a laser displacement sensor (DS) assembly 110 oriented to image an object 120. In the illustrated example, the DS assembly 110 can be contained in a single housing 112 mounted at an appropriate location with respect to the imaged physical environment. In some embodiments, a DS assembly can comprise discrete, separated subcomponents. In the illustrated example, the object 120 is a structure having a surface 140 having a three-dimensional (3D) profile, in which the height in the physical z-axis direction of the relative coordinate system 124 can vary with respect to the x-axis and y-axis directions of the relative coordinate system 124.

In some embodiments, the object 120 and the DS assembly 110 can be in relative motion with either the displacement sensor 110, the object 120, or both, moving along at least one axis of the relative coordinate system 124 (e.g., the scan motion direction MY marked with a double arrow). For example, the object 120 can be located on a motion conveyance 130 (shown in phantom). Motion data can be provided to the motion drive system 132.

The DS assembly 110 can be configured to project laser lines with reduced or no speckles. Speckle is a phenomenon that can affects lasers and laser line projectors. It is caused by the roughness of the surface that is illuminated causing tiny diffractive regions that give the surface a grainy random “speckle” appearance. The speckle effect is a result of the interference of many waves of the same frequency, having different phases and amplitudes, which add together coherently to give a resultant wave whose amplitude, and therefore intensity, varies randomly. When a surface is illuminated by a light wave, according to diffraction theory, each point on an illuminated surface acts as a source of secondary spherical waves. The light at any point in the scattered light field is made up of waves, which have been scattered from each point on the illuminated surface. If the surface is rough enough to create path-length differences exceeding one wavelength, giving rise to phase changes greater than 2n, the amplitude, and hence the intensity, of the resultant light varies randomly. If light of low coherence (e.g., made up of many wavelengths) is used, a speckle pattern will not normally be observed, because the speckle patterns produced by individual wavelengths have different dimensions and will normally average one another out. However, speckle patterns are inherent in coherent light sources, such as lasers. Speckle can be problematic in certain imaging applications-for example a DS, which projects a laser line (based on a fan formed (e.g.,) by passing a laser beam through an aspherical lens (such as a Powell lens or another appropriate generator including cylinder lenses, holographic, cylinder arrays, linear diffusers, or combinations thereof) onto a surface, and receives the reflected light at a camera sensor along a camera axis that is not parallel to the axis of the laser fan. The DS processor thereby triangulates on the surface profile. However, the lumpy and asymmetric irregularity of the received line light, as a result of speckle, limits the precision of the location of the line by the camera sensor. The lumpiness in the line is read as an error in height of the surface. The reduction of speckle enables a lower uncertainty and higher accuracy measurement of profile by the DS.

In the illustrated example, the DS assembly 110 can include a photonic module. The photonic module can include one or more of a laser beam assembly 150, a moving beam deflector 153, and an optical structure configured to reduce or alleviate speckles. In the illustrated example, the laser beam assembly 150 can be configured to project a beam 152. The beam 152 can be directed to the moving beam deflector 153 (e.g., a mirror), which in the illustrated example turns the central axis 170 of the beam substantially 90 degrees. It should be appreciated that the depicted 90-degree (right) angle is exemplary, and the angle of beam deflection can vary depending upon the configuration of the system. The deflector 153 can include a drive 155 that can cause the deflector to reflect the beam in a lateral, cycling pattern (e.g., left right). In some embodiments, the drive 155 can cause the deflector to pivot on an axis between a +/−angle. The reflected beam can cycle left-right so as to trace out a fan 154 centered around the fan axis 170. The beam of the fan 154 can pass through the optical structure, which in the illustrated example includes the cylinder lens 156 and the linear diffuser 157. The optical structure can generate an optical pattern that can effectively reduce or negate speckle in a manner free of substantial thickening/broadening of the resulting laser line 159.

In the illustrated example, the traced-out line 159 can be along the physical x-axis and transverse to the scan motion direction MY. The fan 158 can reside in a plane substantially perpendicular to a reference plane (e.g., the physical x-y plane of the motion conveyance 130 and/or a plane of the surface 140 of the object 120).

The DS assembly 110 can include an imaging device 160 configured to capture two-dimensional (2D) images of projected laser lines. In the illustrated example, the imaging device 160 includes an optics assembly 162 and an image sensor assembly 164. The image sensor assembly 164 can include an array of photosensitive pixels, which can determine a resolution of 2D images 172 captured by the imaging device 160. Each 2D image 172 can have a plurality of pixel columns extending in an image Y direction (YI) and aligned in an image X direction (XI).

The imaging device 160 can have an optical axis OA that intersects the object 120 in the region of the projected laser line 159. The camera optical axis OA can have a non-parallel (e.g., acute) angle A with respect to the plane of the laser fan 158. The height variations/displacements in the projected laser line 159 along the physical x-axis can be captured by the imaging device 160 as a variation in position in the resulting line 171 of the illustrated exemplary 2D image 172 as shown in an exemplary, optional user interface display 174.

In the illustrated example, the image sensor 164 is operatively interconnected to at least one processor 180, which can be integrated within or reside remotely from the housing 112 of the DS assembly 110. The least one processor 180 can be configured to execute computer-executable instructions. The computer-executable instructions can include instructions for identifying an edge of the captured laser lines with a subpixel precision. Examples of the at least one processor include, but are not limited to, a programmable processor, a field-programmable gate array (FPGA), a digital signal processor (DSP), a central processing unit (CPU), a graphics processing unit (GPU), and/or an application-specific integrated circuit (ASIC).

The least one processor 180 may receive relative motion signals from the motion conveyance 130 or another moving device (e.g., a gantry or manipulator holding the displacement sensor and/or the object). Images can be acquired in association with such motion signals so that the line 171 is registered with the physical position in the physical environment. Images can be stored in an appropriate memory or storage location 188 for subsequent transmission and/or analysis.

The DS assembly 110 can include appropriate vision system tools and processes 183, such as edge detectors, line finders, blob analyzers, calipers, etc. These tools and processes 183 can further process and analyze images provided by the sensor assembly 164, and generate results based upon such analysis. By way of non-limiting example, image data (e.g., a range image or 3D point cloud) and/or analyzed results is/are transmitted to downstream data handling devices and processes for use in various production activities, such as inspection, quality control, object manipulation, assembly, etc.

The least one processor 180 can include a mirror/deflector control module 190, which is interconnected to the beam deflector driver 155. This control module 190 can operate the deflector at an appropriate cycle rate (frequency), and can be based on the acquisition frame rate of the sensor assembly 164 so as to ensure that each image captures a complete trace of the laser line projected on the object surface 140.

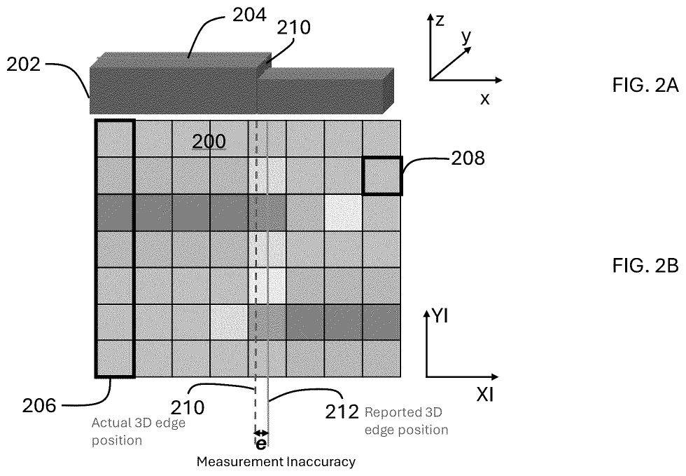

FIG. 2A is a schematic diagram illustrating an object 202 scanned by a laser line 204. In the illustrated example, the object 202 has an edge 210. FIG. 2B is a schematic diagram illustrating a 2D image 200 of the captured laser line. As illustrated, the 2D image 200 can have a plurality of pixel columns 206. Each pixel column 206 can include a plurality of pixels 208 aligned in the image Y direction. The plurality of pixel columns 206 can be aligned in the image X direction. The image Y direction can correspond to the physical z-direction and contain height variation at the edge 210 of the object 202. The image X direction can correspond to the physical x-direction and reflect the edge 210 of the object 202. Conventionally, the middle of the relevant pixel column may be identified as the measured edge 212 and used for generating the 3D edge position, leaving an error e between the measured edge 212 and the actual edge 210. To provide a more accurate measurement in the image X direction, a method to identify the edge with subpixel precision is provided herein.

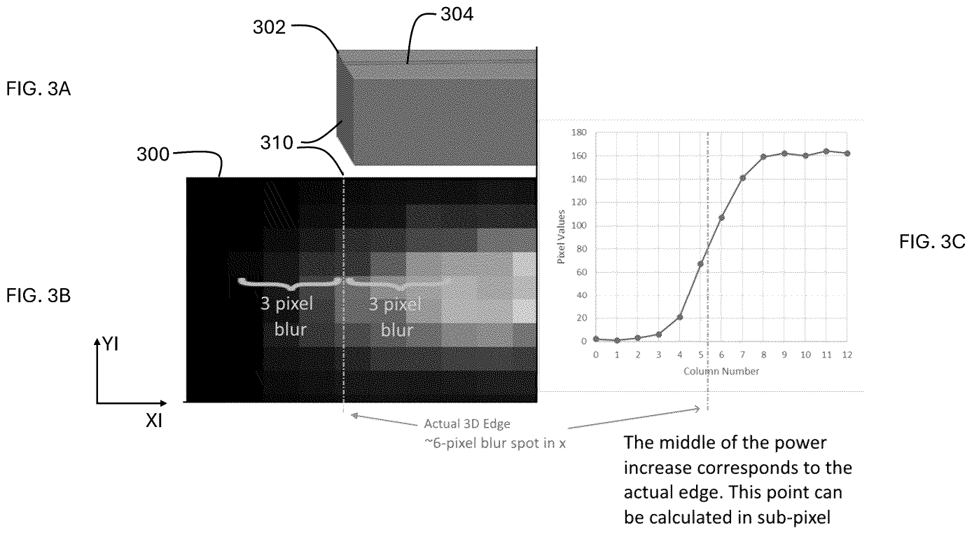

Machine vision systems described herein can leverage the pre-selection of every column in the image to locate the areas to identify an edge of a captured laser line with subpixel precision. FIG. 3A is a schematic diagram illustrating an object 302 scanned by a laser line 304. In the illustrated example, the object 302 has an edge 310. FIG. 3B is a 2D image 300 of the captured laser line across the object 302. As illustrated, the laser line ends in the image X direction can generally be blurred due to, for example, the optics of the imaging device. This can make it difficult to determine the exact position. However, the machine vision system described herein can use this blurring to increases the accuracy of the measurement beyond pixel resolution. FIG. 3C is a graph of the pixel values for individual pixel columns of the 2D image 300. As illustrated, the graph of the pixel values for individual pixel columns includes a brightness ramp around the edge 310.

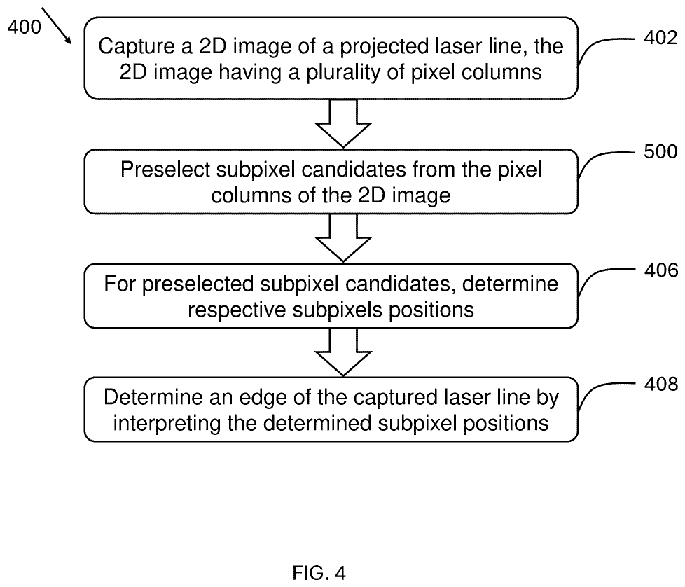

FIG. 4 is a flow chart illustrating a method 400 of providing subpixel precision for a captured laser line in the image X direction. The method 400 can start with capturing, with an imaging device (e.g., imaging device 160), a 2D image of a projected laser line at step 402. The 2D image can include a plurality of pixel columns extending in the image Y direction and aligned in the image X direction. The captured 2D image can be transferred to at least one processor (e.g., processor 180). At step 500, subpixel candidates can be preselected, by the at least one processor, from the pixel columns of the 2D image such that not all of the pixel columns of the 2D image need to proceed to step 406, alleviating computational burden. At step 406, subpixel positions can be determined, by the at least one processor, for preselected subpixel candidates. Examples of methods to determine the subpixel positions include, but are not limited to, reconstructive methods, moments-based methods, and curve-fitting methods. At step 408, an edge of the captured laser line can be determined, by the at least one processor, by interpreting the determined subpixel positions.

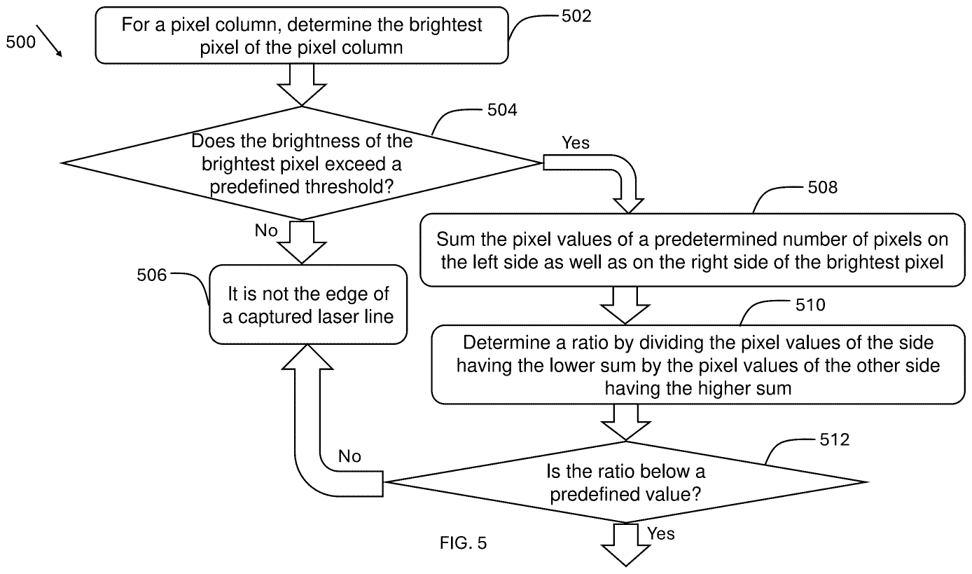

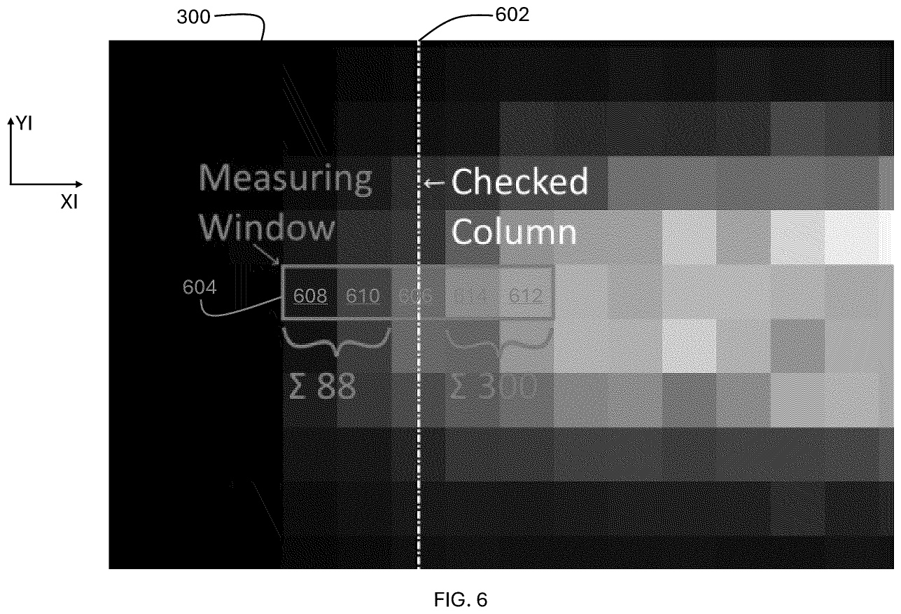

FIG. 5 is a flow chart illustrating a method 500 of preselecting subpixel candidates. The method 500 can start with, for each pixel column, determining the brightest pixel of the pixel column. FIG. 6 is a schematic diagram illustrating applying the method 500 of preselecting subpixel candidates to the 2D image 300, showing a measurement window 604. In the example illustrated in FIG. 6, for pixel column 602, pixel 606 is determined as the brightest.

At step 504, it can be determined whether the brightness of the brightest pixel exceeds a predefined threshold. If the brightness of the brightest pixel does not exceed the predefined threshold, the method 500 can proceed to step 506 where it is determined that the pixel column is not an edge of (e.g., outside) a captured laser line and therefore the pixel column is discarded. If the brightness of the brightest pixel exceeds the predefined threshold, the method 500 can proceed to step 508 where pixel values of a predetermined number of pixels on the left side can be summed, as well as on the right side of the brightest pixel. In the example illustrated in FIG. 6, assuming the brightness of the brightest pixel 606 of the pixel column 602 exceeds a predefined threshold, the brightnesses of the two pixels 608, 610 on the left of pixel 606 are summed and shown as “88.” The brightnesses of the two pixels 612, 614 on the right of pixel 606 are also summed and shown as “300.” The pixels 606, 608, 610, 612, and 614 together can define the measurement window 604 in the image X direction.

Alternatively, at step 508, a ratio can be determined by dividing the pixel values of one of the sides having the higher sum by the pixel values of the other one of the sides having the lower sum. If the ratio exceeds a predefined value, the pixel column is preselected as a subpixel candidate.

At step 510, a ratio can be determined by dividing the pixel values of one of the sides having the lower sum by the pixel values of the other one of the sides having the higher sum. In the example illustrated in FIG. 6, a ratio can be determined by dividing “88” by “300.”

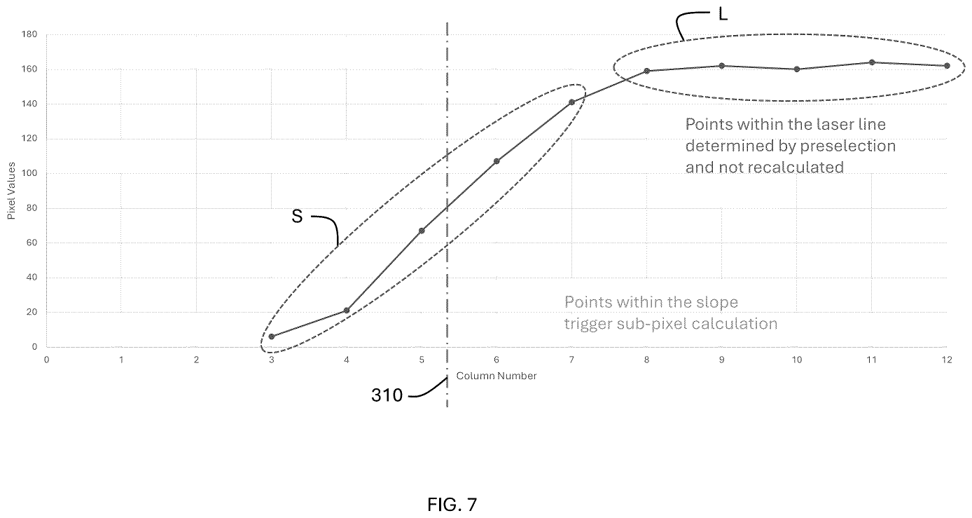

At step 512, it can be determined whether the ratio is below a predefined value. If the ratio is below a predefined value, the pixel column is preselected as a subpixel candidate and a subpixel position will be determined for the pixel column at step 406. If the ratio is not below the predefined value, the method 500 can proceed to step 506 where it is determined that the pixel column is not an edge of (e.g., inside) a captured laser line. FIG. 7 is a schematic diagram illustrating results of applying the method 500 of preselecting subpixel candidates to the 2D image 300. In the example illustrated in FIG. 7, the pixel columns in the circle marked “L” are determined as points within the captured laser line and therefore not a subpixel candidate. The pixel columns in the circle marked “S” are preselected as subpixel candidates. As illustrated, such a method can identify the pixel columns corresponding to the brightness ramp.

For each of the preselected subpixel candidates, a subpixel position can be determined. Examples of methods to determine the subpixel positions include, but are not limited to, reconstructive methods, moments-based methods, and curve-fitting methods. In some embodiments, if the pixel column is preselected as a subpixel candidate, the subpixel position for the pixel column is determined by applying a moments-based method to the measurement window used in preselecting the pixel column as a subpixel candidate. For example, the result of the subpixel position can be a position inside the measurement window.

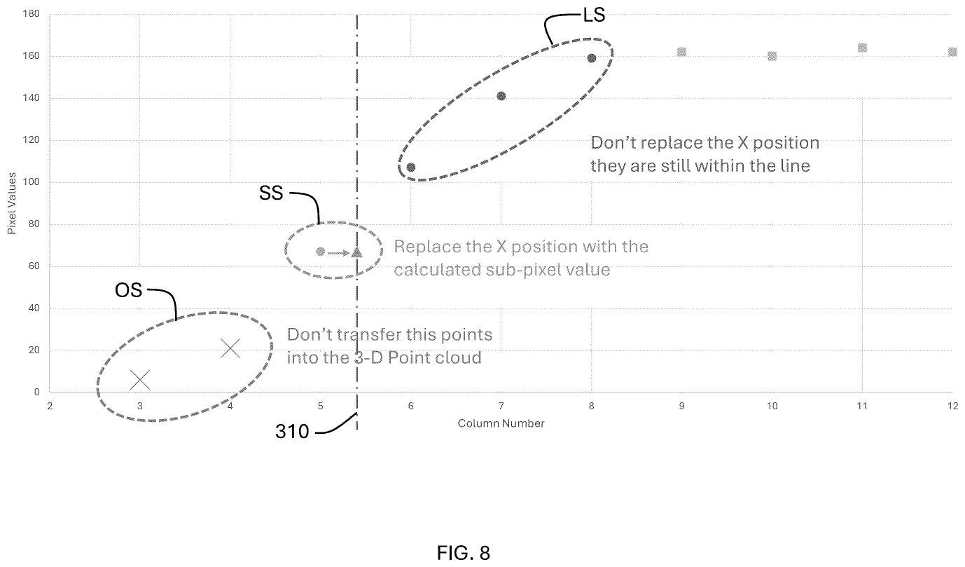

FIG. 8 is a schematic diagram illustrating results of applying a method 800 of interpreting estimated subpixel positions for preselected subpixel candidates of FIG. 7. As illustrated, the pixel column in the circle marked “SS” can be interpreted as the edge of the captured laser line because a distance between the determined subpixel position for the pixel column and a center of the measurement window used in preselecting the pixel column is less than a predetermine length (e.g., half of pixel length). The pixel columns in the circles marked “LS” and “OS” can be interpreted as not the edge of the captured laser line because their respective distances between the determined subpixel positions for the pixel columns and centers of respective measurement windows used in preselecting the pixel columns are not less than the predetermine length. The pixel columns in the circles marked “LS” can be assigned as part of the captured laser line so as to be used for generating the 3D image because their determined subpixel positions are on darker sides of the centers of their respective measurement windows. The pixel columns in the circles marked “OS” can be discarded so as not to be used for generating the 3D image because their determined subpixel positions are on brighter sides of the centers of their respective measurement windows.

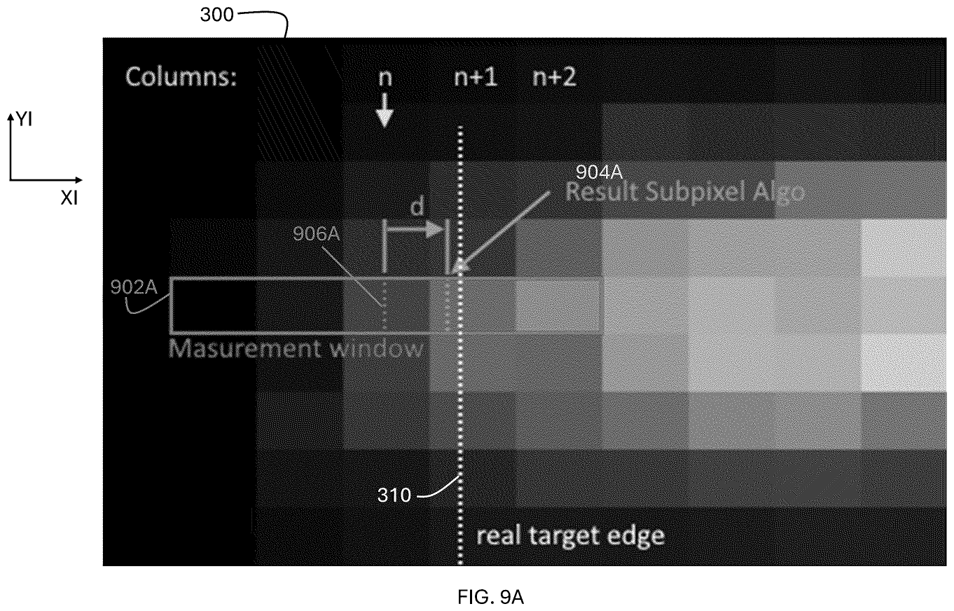

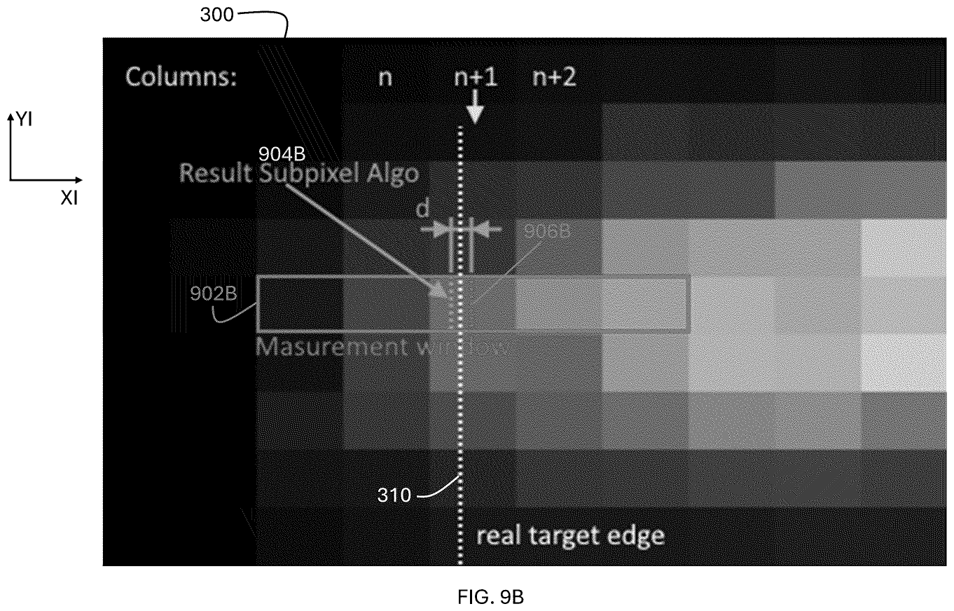

FIGS. 9A-9C are schematic diagrams illustrating potential results between the determined subpixel position in FIG. 8 and the center of a measurement window. As illustrated in FIGS. 9A-9C, a distance d between the determined subpixel position (e.g., positions 904A, 904B, 904C) and a center of the measurement window (e.g., center 906A, 906B, 906C) can be determined. As illustrated in FIG. 9B, if the distance d is less than a predetermined length (e.g., half of pixel length), the determined subpixel position (e.g., position 904B) can be assigned as the edge of the captured laser line. Alternatively, a pixel column that has the smallest d can be determined and assigned as the edge of the captured laser line.

As illustrated in FIGS. 9A and 9C, if the distance d is greater than the predetermined length, it can be determined whether the determined subpixel position is on a brighter side of the center of the measurement window. As illustrated in FIG. 9A, if the determined subpixel position (e.g., position 904A) is on a brighter side of the center (e.g., center 906A) of the measurement window (e.g., window 902A), the pixel column can be discarded so as not to be used for generating the 3D image. As shown, the determined subpixel position 904a is outside the real target edge 310. As illustrated in FIG. 9C, if the determined subpixel position (e.g., position 904° C.) is on a darker side of the center (e.g., 906C) of the measurement window (e.g., 902C), the pixel column can be assigned as part of the captured laser line so as to be used for generating the 3D image. As shown, the determined subpixel position 904c is within the real target edge 310.

It should be appreciated that although the illustrated examples assume the pixel location is in the center of the pixel, and the subpixel location extends to either the left or the right of the center. Alternative embodiments can assume that the pixel position is at the left edge of the pixel and that the subpixel location extends to the right of the left edge. Another alternative embodiment can assume the pixel position is at the right edge of the pixel and the subpixel location extends to the left of the right edge.

It should be appreciated that although the illustrated examples use the brightest pixel in a pixel column as an exemplary metric pixel, other criteria can be used to select the metric pixel. For example, multiple brightest pixels in a pixel column may be determined; and the metric pixel may be selected based on the location of these multiple brightest pixels. For instance, the multiple brightest pixels may correspond to stacked surfaces scanned by the laser line. When the top surface is of interest, the up-most brightest pixel may be selected as the metric pixel. When the bottom surface is of interest, the bottom-most brightest pixel may be selected as the metric pixel. As another example, for a pixel column, the brightnesses of a number (e.g., an odd number n) of adjacent pixels in a pixel column may be summed. If the sum exceeds a predetermined value, the metric pixel may be selected from the number of adjacent pixels (e.g., the center pixel). Alternatively, the metric pixel may be selected based on a curve (e.g., a Gaussian curve) fitted to the number of adjacent pixels.

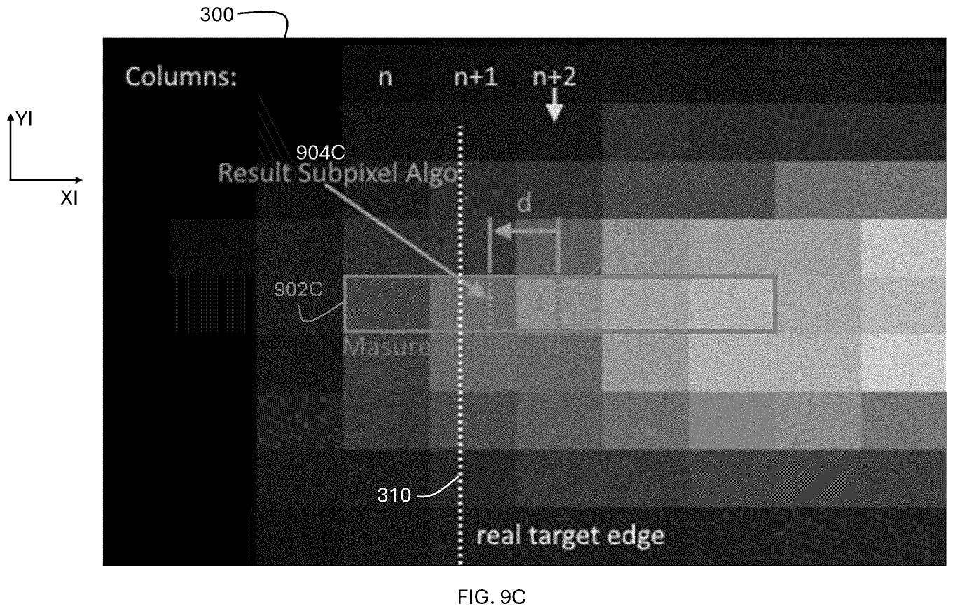

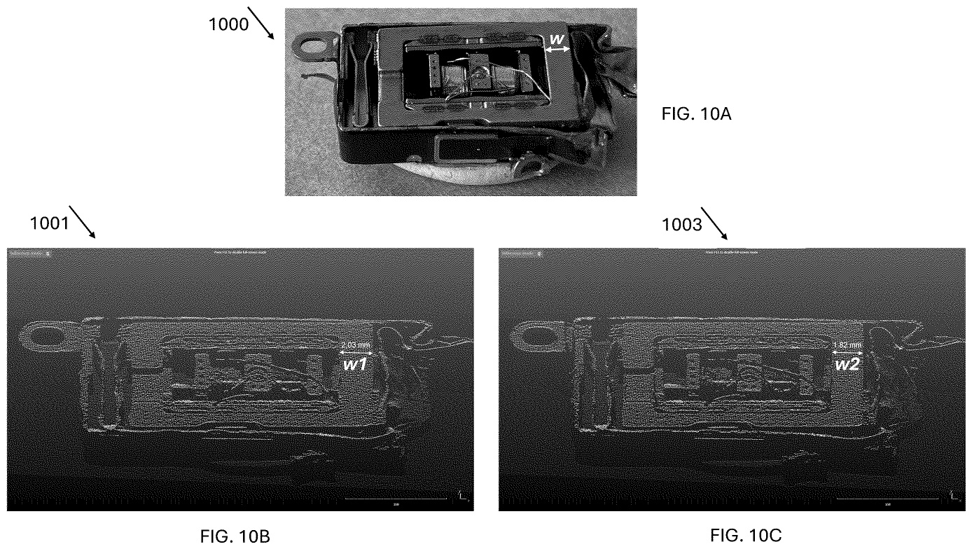

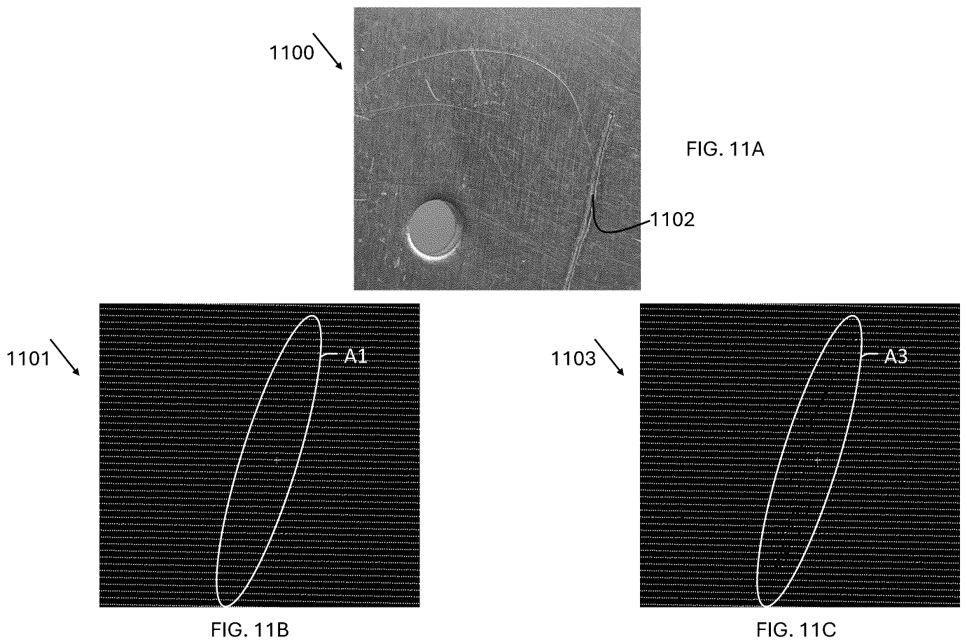

FIGS. 10A-11C illustrate exemplary benefits provided by machine vision systems with subpixel precision. FIG. 10A is an image of an electronic device 1000. The electronic device 1000 has various details including a width w of a feature. FIG. 10B is a 3D image of the electronic device 1000, without subpixel precision for captured laser lines in the image X direction. The width w1 of the feature is measured as 2.03 mm. FIG. 10C is a 3D image of the electronic device 1000, with subpixel precision for captured laser lines in the image X direction. The width w2 of the feature is measured as 1.82 mm. Clearly, the 3D image with subpixel precision provides more accurate edge positions and therefore more accurate measurement.

FIG. 11A is an image of a surface 1100 with a hole and scratches including scratch 1102. FIG. 11B is a 3D image of the surface 1100, without subpixel precision for captured laser lines in the image X direction. The area corresponding to the scratch 1102 is marked by circle “A1.” FIG. 11C is a 3D image of the surface 1100, with subpixel precision for captured laser lines in the image X direction. The area corresponding to the scratch 1102 is marked by circle “A2.” Clearly, while the machine vision system without subpixel precision cannot detect the scratch 1102, the machine vision system with subpixel precision is able to capture the scratch 1102.

Various aspects are described in this disclosure, which include, but are not limited to, the following aspects:
1. A system configured to generate a three-dimensional (3D) image of a physical environment, the system comprising: a photonic module configured to project a line onto a surface in the physical environment, wherein the photonic module and the surface are in relative motion in a first physical direction; an imaging device configured to capture a two-dimensional (2D) image of the projected line, the 2D image comprising a plurality of pixel columns extending in an image Y direction and aligned in an image X direction, the image X direction corresponding to a second physical direction perpendicular to the first physical direction, the image Y direction corresponding to a third physical direction perpendicular to both the first physical direction and the second physical direction; and at least one processor configured to identify an edge of the captured line with a subpixel precision in the image X direction.
2. The system of aspect 1 or any other aspect, wherein the at least one processor is configured to: preselect a plurality of subpixel candidates from the plurality of pixel columns; for the plurality of preselected subpixel candidates, determine respective subpixel positions; and determine the edge of the captured laser line by interpreting the determined subpixels positions.
3. The system of aspect 2 or any other aspect, wherein the plurality of subpixel candidates are preselected based on metric pixels of respective pixel columns.
4. The system of aspect 3 or any other aspect, wherein the processor is configured to, for each of the plurality of pixel columns: determine the metric pixel of the pixel column; determine whether the brightness of the metric pixel exceeds a predefined threshold; if the brightness of the metric pixel exceeds the predefined threshold, sum pixel values of a predetermined number of pixels on the left side as well as on the right side of the metric pixel; determine a ratio by dividing the pixel values of one of the sides having the lower sum by the pixel values of the other one of the sides having the higher sum; and if the ratio is below a predefine value, preselect the pixel column as a subpixel candidate.
5. The system of aspect 3 or any other aspect, wherein the processor is configured to, for each of the plurality of pixel columns: determine the metric pixel of the pixel column; determine whether the brightness of the metric pixel exceeds a predefined threshold; if the brightness of the metric pixel exceeds the predefined threshold, sum pixel values of a predetermined number of pixels on the left side as well as on the right side of the metric pixel; determine a ratio by dividing the pixel values of one of the sides having the higher sum by the pixel values of the other one of the sides having the lower sum; and if the ratio exceeds a predefine value, preselect the pixel column as a subpixel candidate.
6. The system of aspect 4 or 5 or any other aspect, wherein: the metric pixel and the predetermined number of pixels on the left and right sides of the metric pixel together define a measurement window in the image X direction; and if the pixel column is preselected as a subpixel candidate, the subpixel position for the pixel column is determined by applying a moments-based method to the measurement window.
7. The system of aspect 6 or any other aspect, wherein the processor is configured to: determine a distance between the determined subpixel position and a center of the measurement window; and if the distance is less than a predetermined length, assign the determined subpixel position as the edge of the captured line.
8. The system of aspect 7 or any other aspect, wherein the processor is configured to, if the distance is greater than the predetermined length: determine whether the determined subpixel position is on a brighter side of the center of the measurement window; if the determined subpixel position is on a brighter side of the center of the measurement window, discard the pixel column; and if the determined subpixel position is on a darker side of the center of the measurement window, assign the pixel column as part of the captured line.
9. The system of aspect 7 or 8 or any other aspect, wherein the determined length is a half of a pixel length in the image X direction.
10. The system of aspect 6 or any other aspect, wherein the processor is configured to: for each of the determined subpixel candidates, determine a distance between the determined subpixel position and a center of the respective measurement window; and assign the subpixel candidate that has a smallest distance as the edge of the captured line.
11. The system of any one of aspects 2-5 or any other aspect, wherein for the preselected subpixel candidates, the subpixel positions are determined by a moments-based method.
12. The system of any one of aspects 2-5 or any other aspect, wherein for the preselected subpixel candidates, the subpixel positions are determined by a curve-fitting method.
13. The system of any preceding aspect or any other aspect, wherein the processor comprises a field-programmable gate array (FPGA).
14. The system of any preceding aspect or any other aspect, wherein the photonic module is configured to project the line onto the surface in the physical environment with reduced speckle.
15. A method for generating a three-dimensional (3D) image of a physical environment, the method comprising: projecting a line onto a surface in the physical environment, wherein the line and the surface are in relative motion in a first physical directions; capturing a two-dimensional (2D) image of the projected line, the 2D image comprising a plurality of pixel columns extending in an image Y direction and aligned in an image X direction, the image X direction corresponding to a second physical direction perpendicular to the first physical direction, the image Y direction corresponding to a third physical direction perpendicular to both the first physical direction and the second physical direction; and identifying an edge of the captured line with a subpixel precision in the image X direction.
16. The method of aspect 15 or any other aspect, comprising: preselecting a plurality of subpixel candidates from the plurality of pixel columns; for the plurality of preselected subpixel candidates, determining respective subpixel positions; and determining the edge of the captured laser line by interpreting the determined subpixels positions.
17. The method of aspect 16 or any other aspect, wherein the plurality of subpixel candidates are preselected based on metric pixels of respective pixel columns.
18. The method of aspect 17 or any other aspect, comprising, for each of the plurality of pixel columns: determining the metric pixel of the pixel column; determining whether the brightness of the metric pixel exceeds a predefined threshold; if the brightness of the metric pixel exceeds the predefined threshold, summing pixel values of a predetermined number of pixels on the left side as well as on the right side of the metric pixel; determining a ratio by dividing the pixel values of one of the sides having the lower sum by the pixel values of the other one of the sides having the higher sum; and if the ratio is below a predefine value, preselecting the pixel column as a subpixel candidate.
19. The method of aspect 17 or any other aspect, comprising, for each of the plurality of pixel columns: determining the metric pixel of the pixel column; determining whether the brightness of the metric pixel exceeds a predefined threshold; if the brightness of the metric pixel exceeds the predefined threshold, summing pixel values of a predetermined number of pixels on the left side as well as on the right side of the metric pixel; determining a ratio by dividing the pixel values of one of the sides having the higher sum by the pixel values of the other one of the sides having the lower sum; and if the ratio exceeds a predefine value, preselecting the pixel column as a subpixel candidate.
20. The method of aspect 18 or 19 or any other aspect, wherein: the metric pixel and the predetermined number of pixels on the left and right sides of the metric pixel together define a measurement window in the image X direction; and if the pixel column is preselected as a subpixel candidate, the subpixel position for the pixel column is determined by applying a moments-based method to the measurement window.
21. The method of aspect 20 or any other aspect, comprising: determining a distance between the determined subpixel position and a center of the measurement window; and if the distance is less than a predetermined length, assigning the determined subpixel position as the edge of the captured line.
22. The method of aspect 21 or any other aspect, comprising, if the distance is greater than the predetermined length: determine whether the determined subpixel position is on a brighter side of the center of the measurement window; if the determined subpixel position is on a brighter side of the center of the measurement window, discard the pixel column; and if the determined subpixel position is on a darker side of the center of the measurement window, assign the pixel column as part of the captured line.
23. The method of aspect 21 or 22 or any other aspect, wherein the determined length is a half of a pixel length in the image X direction.
24. The method of aspect 20 or any other aspect, comprising: for each of the determined subpixel candidates, determining a distance between the determined subpixel position and a center of the respective measurement window; and assigning the subpixel candidate that has a smallest distance as the edge of the captured line.

Having thus described several aspects of several embodiments of a machine vision system and method of operating the machine vision system, it is to be appreciated that various alterations, modifications, and improvements will readily occur to those skilled in the art. Such alterations, modifications, and improvements are intended to be part of this disclosure, and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

Further, though some advantages of the present disclosure may be indicated, it should be appreciated that not every embodiment of the disclosure will include every described advantage. Some embodiments may not implement any features described as advantageous. Accordingly, the foregoing description and drawings are by way of example only.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be understood that the above-described acts of the methods described herein can be executed or performed in any order or sequence not limited to the order and sequence shown and described. Also, some of the above acts of the methods described herein can be executed or performed substantially simultaneously where appropriate or in parallel to reduce latency and processing times.

All definitions, as defined and used, should be understood to control over dictionary definitions, definitions in documents incorporated by reference, and/or ordinary meanings of the defined terms.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A system configured to generate a three-dimensional (3D) image of a physical environment, the system comprising:
a photonic module configured to project a line onto a surface in the physical environment, wherein the photonic module and the surface are in relative motion in a first physical direction;
an imaging device configured to capture a two-dimensional (2D) image of the projected line, the 2D image comprising a plurality of pixel columns extending in an image Y direction and aligned in an image X direction, the image X direction corresponding to a second physical direction perpendicular to the first physical direction, the image Y direction corresponding to a third physical direction perpendicular to both the first physical direction and the second physical direction; and
at least one processor configured to identify an edge of the captured line with a subpixel precision in the image X direction.

2. The system of claim 1, wherein the at least one processor is configured to:
preselect a plurality of subpixel candidates from the plurality of pixel columns;
for the plurality of preselected subpixel candidates, determine respective subpixel positions; and
determine the edge of the captured laser line by interpreting the determined subpixels positions.

3. The system of claim 2, wherein:
the plurality of subpixel candidates are preselected based on metric pixels of respective pixel columns.

4. The system of claim 3, wherein the processor is configured to, for each of the plurality of pixel columns:
determine the metric pixel of the pixel column;
determine whether the brightness of the metric pixel exceeds a predefined threshold;
if the brightness of the metric pixel exceeds the predefined threshold, sum pixel values of a predetermined number of pixels on the left side as well as on the right side of the metric pixel;
determine a ratio by dividing the pixel values of one of the sides having the lower sum by the pixel values of the other one of the sides having the higher sum; and
if the ratio is below a predefine value, preselect the pixel column as a subpixel candidate.

5. The system of claim 3, wherein the processor is configured to, for each of the plurality of pixel columns:
determine the metric pixel of the pixel column;
determine whether the brightness of the metric pixel exceeds a predefined threshold;
if the brightness of the metric pixel exceeds the predefined threshold, sum pixel values of a predetermined number of pixels on the left side as well as on the right side of the metric pixel;
determine a ratio by dividing the pixel values of one of the sides having the higher sum by the pixel values of the other one of the sides having the lower sum; and
if the ratio exceeds a predefine value, preselect the pixel column as a subpixel candidate.

6. The system of claim 4, wherein:
the metric pixel and the predetermined number of pixels on the left and right sides of the metric pixel together define a measurement window in the image X direction; and
if the pixel column is preselected as a subpixel candidate, the subpixel position for the pixel column is determined by applying a moments-based method to the measurement window.

7. The system of claim 6, wherein the processor is configured to:
determine a distance between the determined subpixel position and a center of the measurement window; and
if the distance is less than a predetermined length, assign the determined subpixel position as the edge of the captured line.

8. The system of claim 7, wherein the processor is configured to, if the distance is greater than the predetermined length:
determine whether the determined subpixel position is on a brighter side of the center of the measurement window;
if the determined subpixel position is on a brighter side of the center of the measurement window, discard the pixel column; and
if the determined subpixel position is on a darker side of the center of the measurement window, assign the pixel column as part of the captured line.

9. The system of claim 7, wherein:
the determined length is a half of a pixel length in the image X direction.

10. The system of claim 6, wherein the processor is configured to:
for each of the determined subpixel candidates, determine a distance between the determined subpixel position and a center of the respective measurement window; and
assign the subpixel candidate that has a smallest distance as the edge of the captured line.

11. The system of claim 2, wherein:
for the preselected subpixel candidates, the subpixel positions are determined by a moments-based method.

12. The system of claim 2, wherein:
for the preselected subpixel candidates, the subpixel positions are determined by a curve-fitting method.

13. The system of claim 1, wherein:
the processor comprises a field-programmable gate array (FPGA).

14. The system of claim 1, wherein:
the photonic module is configured to project the line onto the surface in the physical environment with reduced speckle.

15. A method for generating a three-dimensional (3D) image of a physical environment, the method comprising:
projecting a line onto a surface in the physical environment, wherein the line and the surface are in relative motion in a first physical directions;
capturing a two-dimensional (2D) image of the projected line, the 2D image comprising a plurality of pixel columns extending in an image Y direction and aligned in an image X direction, the image X direction corresponding to a second physical direction perpendicular to the first physical direction, the image Y direction corresponding to a third physical direction perpendicular to both the first physical direction and the second physical direction; and
identifying an edge of the captured line with a subpixel precision in the image X direction.

16. The method of claim 15, comprising:
preselecting a plurality of subpixel candidates from the plurality of pixel columns;
for the plurality of preselected subpixel candidates, determining respective subpixel positions; and
determining the edge of the captured laser line by interpreting the determined subpixels positions.

17. The method of claim 16, wherein:
the plurality of subpixel candidates are preselected based on metric pixels of respective pixel columns.

18. The method of claim 17, comprising, for each of the plurality of pixel columns:
determining the metric pixel of the pixel column;
determining whether the brightness of the metric pixel exceeds a predefined threshold;
if the brightness of the metric pixel exceeds the predefined threshold, summing pixel values of a predetermined number of pixels on the left side as well as on the right side of the metric pixel;
determining a ratio by dividing the pixel values of one of the sides having the lower sum by the pixel values of the other one of the sides having the higher sum; and
if the ratio is below a predefine value, preselecting the pixel column as a subpixel candidate.

19. The method of claim 17, comprising, for each of the plurality of pixel columns:
determining the metric pixel of the pixel column;
determining whether the brightness of the metric pixel exceeds a predefined threshold;
if the brightness of the metric pixel exceeds the predefined threshold, summing pixel values of a predetermined number of pixels on the left side as well as on the right side of the metric pixel;
determining a ratio by dividing the pixel values of one of the sides having the higher sum by the pixel values of the other one of the sides having the lower sum; and
if the ratio exceeds a predefine value, preselecting the pixel column as a subpixel candidate.

20. The method of claim 18, wherein:
the metric pixel and the predetermined number of pixels on the left and right sides of the metric pixel together define a measurement window in the image X direction; and
if the pixel column is preselected as a subpixel candidate, the subpixel position for the pixel column is determined by applying a moments-based method to the measurement window.
